(19) United States
(12) Patent Application Publication
(10) Pub. No.: US 2014/0346921 A1
(43) Pub. Date: Nov. 27, 2014

(54) DEVICE FOR RETAINING A MACHINE COMPONENT IN AN ELECTRIC MACHINE AND ELECTRIC MACHINE

(71) Applicant: Robert Bosch GmbH, Stuttgart (DE)

(72) Inventors: Claudius Muschelknautz, Buehl (DE); Roland Schmidt, Buehl (DE); Christoph Heier, lffezheim (DE); Tilo Koenig, Buehl (DE); Joerg Schmid, Achern (DE); Samir Mahfoudh, Buehl (DE); Claude Berling, Drusenheim (FR); Jerome Thiery, Strasbourg (FR)

(73) Assignee: Robert Bosch GmbH, Stuttgart (DE)

(21) Appl. No.: 14/369,756

(22) PCT Filed: Nov. 19, 2012
(86) PCT No.: PCT/EP2012/072941

§ 371 Date: Jun. 30, 2014

(30) Foreign Application Priority Data
Dec. 29, 2011 (DE) 10 2011 090 076.4

(51) Int. Cl. H02K 1/18

(52) U.S. Cl. CPC H02K 1/185
USPC 310/216.131

(57) ABSTRACT

The invention relates to a device for retaining a machine component (3), in particular a stator, in a housing (2, 13) of an electric machine, wherein a pressure element (20) is provided in the housing (2, 13) in order to press the machine component (3) with a force against a stop (31).

### BACKGROUND OF THE INVENTION

The present invention relates to electric machines, in particular electronically commutated electric machines. The invention further relates to measures for fixing a stator in a housing of an electric machine.

Electric machines are used in various ways. In particular electronically commutated, i.e. brushless electric machines have the advantage that commutators and carbon brushes which are subject to wear are not used. When using electronically commutated machines, it is necessary to protect the stator winding in a suitable manner from electrically conductive particles, such as, e.g., spray water through the use of a housing. When using electronically commutated machines comprising wet-running rotors, such as, e.g., in pumps, it is furthermore necessary to protect the stator winding in a suitable manner from the inside from electrically conductive particles, such as, e.g. the medium to be pumped, by means of a housing.

To enable fixing, stators or individual parts of stators are usually connected to the housing by means of adhesive bonding, screws, welding, rolling or shrinking or are extrusion-coated as one piece with the housing. Such a fixation has, however, the disadvantage that inertia forces due to internal vibrations by means of magnetic fields or external vibrations due to influences from the environment and temperature fluctuations can impair the reliability of the fixation of the stator winding in the motor housing. In addition, large component tolerances and varying thermal expansions of the components of the stator have to be compensated.

In particular when using such electric machines in pumps for water mixtures for use in automotive and HVACR technologies as well as in pumps for gasoline and diesel mixtures, gearshift mechanisms, e-bikes and steering applications, permanent vibrations act on the stator or the stator winding. In particular in the case of pumps which must have a long service life, conventional fastening techniques for disposal of the stator or, respectively, the stator winding do not ensure a sufficient reliability.

### SUMMARY OF THE INVENTION

The aim of the present invention is to provide a device for retaining a machine component, in particular a stator, in a housing of an electric machine, with which device the machine component is reliably disposed in the housing over the entire service life thereof.

The aforementioned aim is met by the device for retaining a machine component in a housing of an electric machine according to the invention as well as by the electric machine and the method for disposing a machine component in a housing of an electric machine according to the invention.

According to a first aspect, a device for retaining a machine component, in particular a stator, in a housing of an electric machine is provided, wherein a pressure element is provided in the housing in order to press the machine component with a, in particular axial, force against a stop, whereat the machine component is retained in a positive-locking manner.

A concept of the device mentioned above consists of pressing the machine component against a stop while permanently subjecting said component to force, the stator being held against a displacement transversely to the direction in which the force is applied. In this way, it is possible to compensate for tolerances and differing thermal expansion characteristics in the direction which the force is applied and to reliably retain the machine component at a defined position in the interior of the housing of the electric machine by means of the positive fit. As a result, a machine component can be disposed in such a manner in a housing of an electric machine that said component can be retained with a high degree of reliability over the entire service life of the electric machine despite the influence of high inertia forces and temperature fluctuations.

In addition, provision can be made for a retaining device which, with respect to the machine component, lies across from the pressure element in the direction in which the force is applied and has retaining elements that engage in one or a plurality of recesses of the machine component in order to position and fix said machine component against a misalignment in a direction that is transverse to the direction in which the force is applied.

In particular, the one or the plurality of retaining elements can be disposed on a housing cover or on the housing; and the one or the plurality of recesses can be provided on the machine component.

According to one embodiment, one of the retaining elements can be provided with a pressing nib, wherein deformations and/or shears result when inserting the retaining element into the corresponding recess and thus a backlash-free pairing of the retaining elements in the recesses is ensured.

Provision can be made for the pressure element to comprise at least one retaining pin including a spring element mounted thereto, such as, for example, a coiled spring, wherein the retaining pin is inserted into one of the recesses in such a manner that the spring element is preloaded and presses the machine component against the stop.

According to a further embodiment, an external dimension of the machine component and an internal dimension of the housing can be designed such that, when inserting the machine component into the housing, one or a plurality of pressing tabs which are disposed on the external dimension of the machine component are deformed in order to ensure a force fit of the machine component in the housing.

In addition, one or a plurality of pressing tabs can be provided with one or a plurality of contact area(s) which is/are accommodated in recesses of the machine component.

Provision can furthermore be made for the one or plurality of pressing tabs to have vaulted structures that point away from the machine component.

According to a further aspect, an electric machine is provided, comprising:
a housing;
a machine component disposed in the housing, in particular a stator, and
a pressure element which is disposed between the machine component and the housing in order to press the machine component with an axially directed force against a stop.

According to a further aspect, a device is provided for fixing a machine component in a housing of an electric machine having a cylindrical housing, comprising:
an insulating element for electrically insulating the machine component, wherein the insulating element can be disposed in an axial direction adjacent to the machine component;
one or a plurality of pressing tabs which is integrally designed with the insulating element and protrudes from the insulating element in the axial direction.

The one or a plurality of press lugs can be furnished with one or a plurality of contact areas, which can be accommodated in recesses of the machine component, wherein the one or the plurality of pressing tabs has a vaulted structure, which points away from the machine component when mounting the housing onto the machine component.

According to a further aspect, an electric machine is provided, comprising:
a housing;
a machine component disposed in the housing, in particular a stator;
an insulating element for electrically insulating the machine component, wherein the insulating element is disposed in an axial direction adjacent to the machine component;
one or a plurality of pressing tabs which is integrally formed with the insulating element and extends in the axial direction above the machine component.

### BRIEF DESCRIPTION OF THE DRAWINGS

Preferred embodiments of the present invention are explained in detail below with the aid of the attached drawings. In the drawings:

FIG. 1 shows a cross sectional depiction of a pump comprising an electronically commutated electric motor;

FIG. 2 shows a perspective view of a housing part for inserting a stator for the pump of FIG. 1;

FIG. 3 shows a pressure element for fixing the stator in the housing part of FIG. 2;

FIG. 4 shows a stator to be inserted into the housing part of FIG. 2 and to be fixed by the pressure element of FIG. 3; and

FIG. 5 shows a section of a schematic cross sectional view through the stator comprising the pressing tabs disposed thereon.

### DETAILED DESCRIPTION

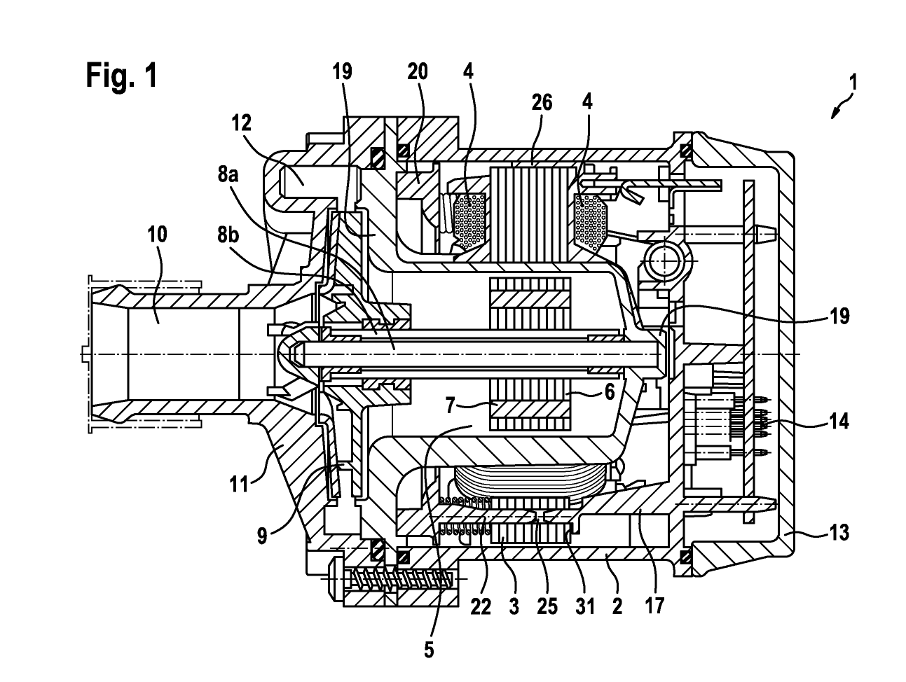

With the aid of FIGS. 1 to 5, the device for securing a stator in an electric machine is explained below by way of example for a water pump.

An electrically operated pump 1 is depicted in FIG. 1 in a cross-sectional view. The pump 1 has a compact disposal in which an electric machine is coupled to a delivery device for pumping a fluid and is encapsulated in a common housing with said device.

The pump 1 comprises a housing including a substantially cylindrical housing part 2 for accommodating a stator 3. The stator 3 is part of an electric internal rotor machine and includes a stator winding 4 comprising a plurality of stator coils, which are disposed on stator teeth that are not depicted. The stator 3 surrounds an inner recess 5 for accommodating a rotor 6.

An axial end of the cylindrical housing part 2 is closed by an intermediate part 19, said intermediate part 19 having a pot-like, cylindrical concavity which protrudes into the inner recess 5 of the stator 3. The dimensions of the pot-like, cylindrical concavity are matched to the inner circumference of the inner recess 5 of the stator 3; thus enabling the stator 3 to abut against the concavity or to be spaced apart from the concavity only at a small distance.

The rotor 6 is disposed in the pot-like concavity of the intermediate part 19. The rotor 6 is equipped with permanent magnets 7 and disposed on a rotor shaft 8b which can be designed as a hollow shaft. The rotor shaft 8b is mounted on an axis 8a and is coupled to a feed wheel 9 which serves to pump a liquid through an intake opening 10 in the direction of an outlet opening 12. The intake opening 10 and the outlet opening 12 are arranged in a pump cover 11 which is disposed oppositely to the housing part 2 on the intermediate part 19. A pump chamber in which the rotor 6 and the feed wheel 9 are disposed is formed between the intermediate part 19 and the pump cover 11.

The one side of the axis 8a is mounted or integrally formed in the intermediate part. A further mounting of the axis 8a is located in the pump chamber and is connected there to the pump cover 11.

The housing part 2 of the pump 1 is closed at a head end opposite to the intermediate part 19 by a housing cover 13. The housing cover 13 together with the housing part 2 and the pump cover 11 forms the housing.

In order to electrically contact the stator 3, connections in the form of wires or conductor strips extend through the housing part 2 up into the housing cover 13. The connections 14 can be connected to a printed circuit board in the housing.

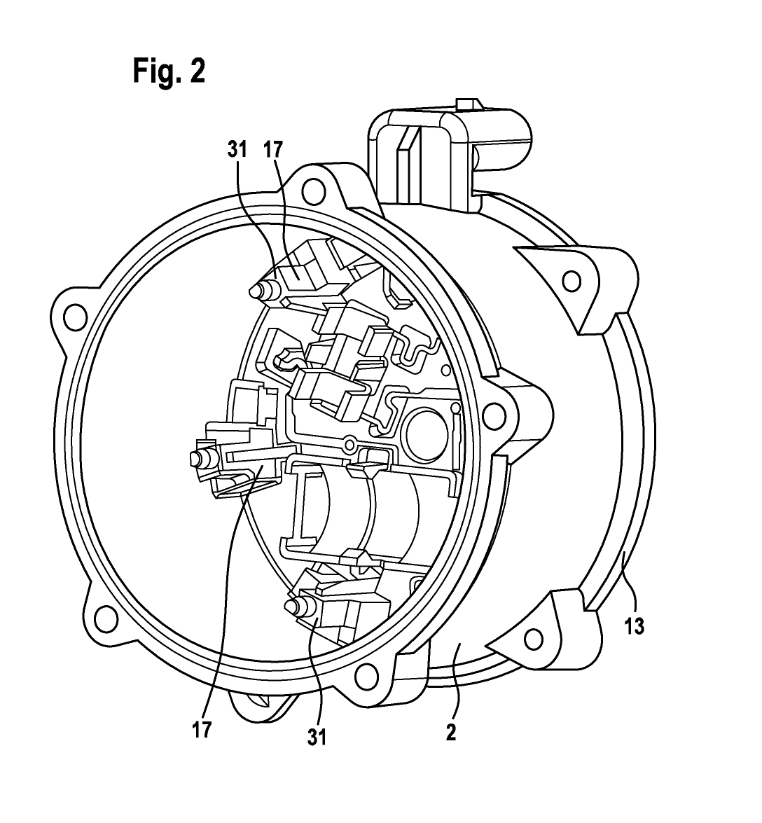

The housing part 2 is depicted in a perspective view in FIG. 2.

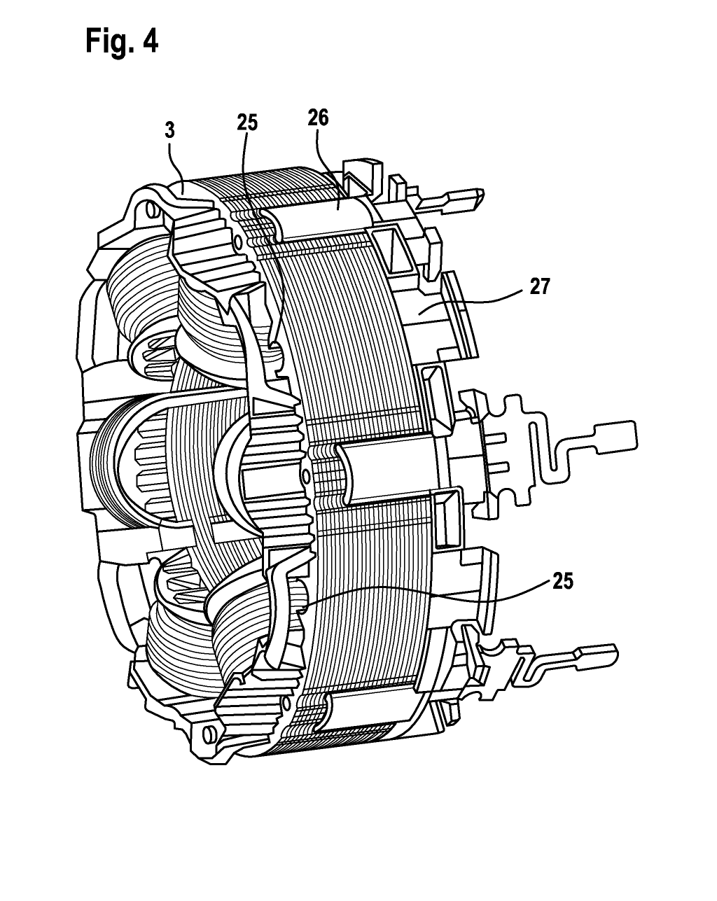

The stator 3 is disposed in the interior of the housing part 2 of the pump. To enable fixing, the stator is axially braced. To this end, provision is made for a plurality of contact surfaces 31 which are provided by a plurality of retaining elements 17 that can be integrally formed with the housing part 2. The retaining elements 17 ideally still have a form-fit connection to recesses 25 of the stator 3 so that the tangential forces are not transferred via the frictional locking connection of the axial bracing. The recesses 25 can particularly be seen in the perspective view of the stator 3 in FIG. 4.

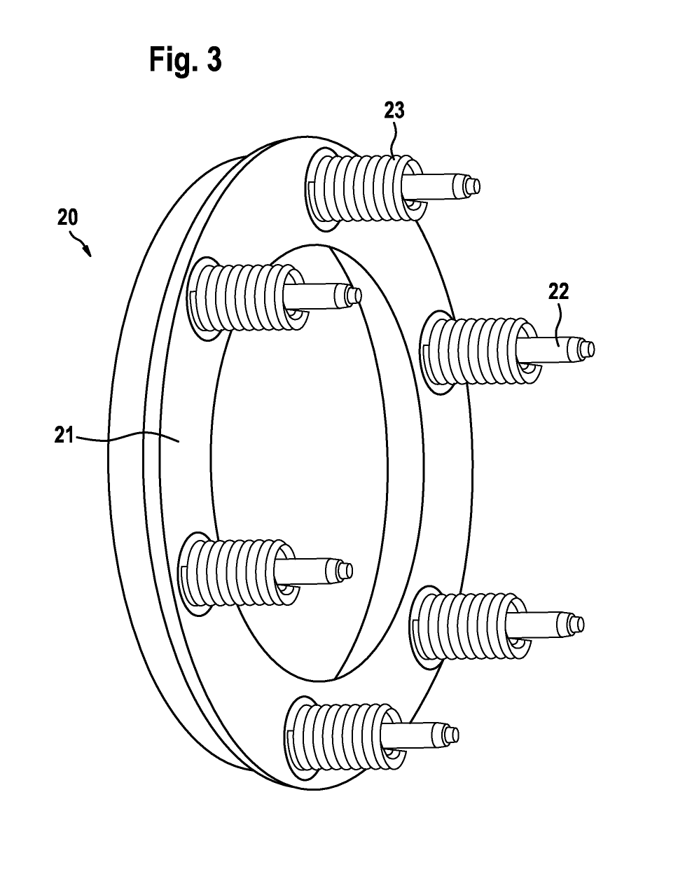

In addition, a pressure element 20 is provided that is depicted in more detail in FIG. 3. The pressure element 20 is preferably of annular configuration and comprises a circular pressure plate 21. One or a plurality of retaining pins 22 is disposed on the pressure plate 21 which pin(s) extend(s) in the axial direction in an aligned manner. The retaining pins 22 are equipped with coil springs in order to exert an axial compressive force on the machine component, in particular of a stator, in the direction of the protruding retaining pins 22.

When assembling the pump 1, the stator 3 is initially introduced into the housing part 2 and placed on the retaining elements 17; and subsequently the pressure element 20 is placed on the stator 3 in such a manner that the retaining pins 22 engage in the recesses 25 of the stator 3. In so doing, the retaining pins 22 engage in the same recesses 25 as the retaining elements 17; however on the other axial side of the stator 3.

The intermediate part 19 is subsequently placed on the pressure element 20 and pressed on until contact is made with the housing part 2; thus enabling the retaining pins 22 to be pressed deeper into the recesses 25 of the stator 3 and thereby the coil springs 23 to be preloaded. As a result, the stator 3 is braced and reliably retained between the retaining elements 17 of the housing part 2 and the retaining pins 22 of the pressure element 20.

The provision of coil springs 23 enables component tolerances and thermal expansions to be compensated without the reliability of the fixation of the stator being compromised over the service life thereof. The contact pressing force of the pressure element 20 is selected such that said force is always greater than the inertia force occurring during the operation of the pump 1. By using helical compression springs 23, a flat spring characteristic curve can be realized so that length tolerances, in particular those of the laminated disk pack of the stator, do not lead to any major changes in force on the stator 3.

The retaining elements 17 on the housing part 2 preferably comprise pressing nibs which lead to shears and/or deformations when press-fitting the stator 3; thus enabling a backlash-free connection to result in the radial direction. In so doing, a tipping of the stator 3 with respect to the rotational axis of the rotor 6 can particularly be ruled out.

As can be seen particularly in FIG. 4, pressing tabs 26 are mounted between the stator 3 and the housing part 2 in the radial direction in order to improve centering and to enable a robust and vibration-optimized fixation. The pressing tabs 26 can be integrally formed with the insulating mask 27 and be disposed in the region of the outside diameter of the stator. The insulating mask 27 can be substantially of annular configuration and abut against a laminated disk pack of the stator 3. The insulating mask 27 can accommodate additional components or take on the functions of wire deposition, wire guidance and interconnecting of components. The primary purpose thereof is however to insulate the stator winding 4 from the laminated disk pack so that damage to the lacquer of the winding wire of the stator winding 4 by the sharp edges of the disk pack is prevented. Hence, a short circuit in the stator winding cannot occur. In addition, the configuration of the wire deposition is positively influenced and wires can be deposited in additional grooves during the winding operation, said wires interconnecting different stator windings 4 with each other.

The pressing tabs 26 rest on the laminated disk pack of the stator 3, i.e. on the outer circumferential surface of the disk pack of the stator 3, and extend substantially in the axial direction. The stator 3 including the pressing tabs 26 has a defined oversize in relation to the inside diameter of the housing part 2. The number and location of the pressing tabs 26 are thereby adapted to the housing part 2 such that, for all tolerance positions, the stresses acting on the housing part 2 lead substantially to deformations within the elastic range. The pressing tabs 26 are preferably distributed at regular intervals over the circumference of the stator 3, such as, for example, six pressing tabs 26 at an angular distance of 60 degrees to each other.

When the stator 3 is inserted into the housing part 2, the pressing tabs 26 are pressed together so that an interference fit is ensured. The oversize is selected such that a minimum compression is present at all admissible temperatures and the stresses in the motor housing and the pressing tabs do not become inadmissibly high. For example, a plastic material having the lowest possible thermal expansion coefficients and a high elasticity can be used.

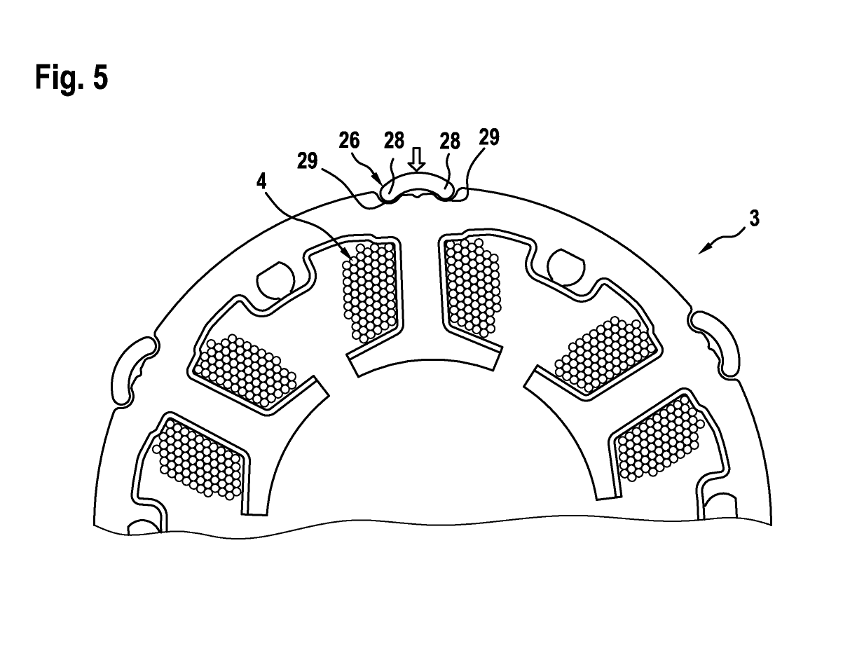

In FIG. 5, a section of a schematic cross-sectional view through the stator 3 including the pressing tabs 26 disposed thereon is depicted. The pressing tabs 26 are convexed outwards, i.e. in the direction of a housing inner wall of the housing part 2 and rest on two contact areas 28 that extend substantially parallel to the axial direction, so as to be spaced apart from one another in the circumferential direction, on an outer surface of the laminated disk pack of the stator 3. To this end, the stator outer surface has two recesses 29, in which the contact areas 28 of the pressing tabs 26 are disposed so that said contact areas are retained from sliding in the circumferential direction. A disposal of the contact areas 28 in the recesses 29 is conditioned by the stability and manufacturability of pressing tabs having a minimum thickness. The embedding of the pressing tabs 26 in the recesses takes place due to compact installation space specifications and advantages resulting from the mutual support of parts.

The contact regions 28 can, for example, be configured as thickenings on the lateral edges of the pressing tabs 26 that have a partially round cross section and preferably extend in the direction opposite to the vaulting of the pressing tabs 26.

Due to the vaulted structure of the pressing lamellae 26, a deformation results during insertion into the housing, by means of which deformation small surfaces of the curved pressing lamellae 26 rest on a housing inner wall of the housing part 2 that has an oversize. As a result, the stator 3 is pressed radially, axially and tangentially via the frictional forces. The deformation is substantially elastic. On account of the provision of the pressing tabs 26, the centering of the stator 3 in the housing can be improved over a large temperature range and at different tolerance positions of the individual parts. In addition, improved noise characteristics are achieved.

1. A device for retaining a machine component (3), in a housing (2, 13) of an electric machine, wherein a pressure element (20) is provided in the housing (2, 13) in order to press the machine component (3) against a stop (31) with a force.

2. The device according to claim 1, wherein a retaining device is provided which, relative to the machine component (3), lies oppositely to the pressure element (20) in a direction in which the force is applied and comprises one or a plurality of recesses (25) as well as one or a plurality of retaining elements (17) that engage(s) in the recess(es) (25) in order to hold the machine component (3) against a misalignment in a direction that is transverse to the direction in which the force is applied.

3. The device according to claim 2, wherein the one or the plurality of retaining elements (17) is disposed on a housing part (2) or a housing cover (13) of the housing, and the one or the plurality of recesses (25) is provided on the machine component (3).

4. The device according to claim 2, wherein at least one of the retaining elements (17) is equipped with a pressing nib which is at least one of deformed and sheared off when inserting the retaining element (17) into the corresponding recess (25), and a backlash-free fit of the at least one retaining element (17) in the corresponding recess (25) is thus ensured.

5. The device according to claim 1, wherein the pressure element (20) has at least one retaining pin (22) comprising a spring element (23) mounted thereon, wherein the retaining pin is inserted into the corresponding recess (25) such that the spring element (25) is preloaded and presses the machine component (3) against the stop (31).

6. The device according to claim 1, wherein an external dimension of the machine component (3) and an internal dimension of the housing (2, 13) are designed in such a way that, when inserting the machine component (3) into the housing (2, 13), one or a plurality of pressing tabs (26) which is disposed on the external dimension of the machine component is deformed in order to ensure an interference fit of the machine component (3) in the housing (2, 13).

7. The device according to claim 6, wherein the one or the plurality of pressing tabs (26) is furnished with one or a plurality of contact areas (28) which are accommodated in recesses (29) of the machine component (3).

8. The device according to claim 6, wherein the one or the plurality of pressing tabs (26) has a vaulted structure which points away from the machine component (3).

9. An electric machine, comprising:
a housing (2, 13);
a machine component (3), disposed in the housing (2, 13);
a pressure element (20) which is disposed between the machine component (3) and the housing (2, 13) in order to press the machine component (3) with a force against a stop (31).

10. The electric machine according to claim 9, wherein a retaining device is provided which, relative to the machine component (3), lies oppositely to the pressure element (20) in a direction in which the force is applied and comprises retaining elements (17) that engage in one or a plurality of recesses (25) in order to hold the machine component (3) against a misalignment in a direction that is transverse to the direction in which the force is applied, wherein the one or the plurality of retaining elements (17) is disposed on a housing part (2) or a housing cover (13) of the housing (2, 13) and the one or the plurality of recesses (25) is provided on the machine component (3).

11. The electric machine according to claim 10, wherein the pressure element (20) has at least one retaining pin (22) comprising a spring element (23) mounted thereon, wherein the machine component (3) comprises a recess (25) in which the retaining pin (23) is inserted such that the spring element (23) is preloaded and presses the machine component (3) against the stop (31).

12. The electric machine according to claim 9, wherein an external dimension of the machine component (3) and an internal dimension of the housing (2, 13) are designed in such a way that, when inserting the machine component (3) into the housing (2, 13), one or a plurality of pressing tabs which is disposed on the external dimension of the machine component (3) is deformed in order to ensure an interference fit of the machine component (3) in the housing (2, 13).

13. A device for fixing a machine component (3) in a housing of an electric machine having a cylindrical housing, comprising:
an insulating element (27) for electrically insulating the machine component (3), wherein the insulating element (27) can be disposed in an axial direction adjacent to the machine component (3); and
one or a plurality of pressing tabs (26) which is integrally formed with the insulating element (27) and protrudes from said insulating element (27) in the axial or a radial direction.

14. The device according to claim 13, wherein the one or the plurality of pressing tabs (26) is equipped with one or a plurality of contact areas (28) which can be accommodated in recesses (29) of the machine component (3), wherein the one or the plurality of pressing tabs (26) has a vaulted structure which, when being placed on the machine component (3), points away from the same.

15. An electric machine, comprising:
a housing (2, 13);
a machine component (3), disposed in the housing (2, 13);
an insulating element (27) for electrically insulating the machine component (3), wherein the insulating element (27) is disposed in an axial direction adjacent to the machine component (3); and
one or a plurality of pressing tabs which is integrally formed with the insulating element (27) and extends beyond the machine component (3) in the axial direction.

16. The device according to claim 1 wherein the machine component is a stator.

17. The device according to claim 1 wherein the force is directed axially.

18. The electric machine according to claim 9 wherein the machine component is a stator.

19. The electric machine according to claim 15 wherein the machine component is a stator.
